(19) United States
(12) Patent Application Publication
(10) Pub. No.: US 2018/0205412 A1
(43) Pub. Date: Jul. 19, 2018

(54) AUTONOMOUS BANDWIDTH SELECT WIRELESS TRANSCIVER

(71) Applicants: Ming Yu Lin, Tustin, CA (US); Qiang Li, Irvine, CA (US)

(72) Inventors: Ming Yu Lin, Tustin, CA (US); Qiang Li, Irvine, CA (US)

(21) Appl. No.: 15/253,196

(22) Filed: Aug. 31, 2016

(51) Int. Cl. H04B 1/403; H04B 1/3805; H04B 1/408

(52) U.S. Cl. CPC H04B 1/406; H04W 88/06; H04B 1/408; H04B 1/3805

(57) ABSTRACT

A wireless transceiver system is disclosed. The system includes a narrow band transmitter. The narrow band transmitter includes at least a delta sigma phased locked loop (delta-sigma PLL) circuit and a non-linear low-power amplifier, where an output of the delta-sigma PLL is coupled to an input of the non-linear low-power amplifier. The system further includes a wide band transmitter. The wide band transmitter includes at least a digital to analog converter (DAC), a low pass filter, a local oscillator mixer and a linear high power amplifier, where an output of the DAC is coupled to an input of the low pass filter and an output of the low pass filter is coupled to an input of the local oscillator mixer and wherein an output of the local oscillator mixer is coupled to an input of the linear high power amplifier.

### CROSS REFERENCE TO RELATED APPLICATIONS

The present disclosure claims the benefit of U.S. Provisional Application No. 62/212,007 entitled “Autonomous Bandwidth Select Wireless Transceiver”, filed on Aug. 31, 2015, which is hereby incorporated by reference in its entirety for all purposes.

### TECHNICAL FIELD

The present disclosure generally relates to wireless system transceivers and in particular to bandwidth select transceivers and efficient transmitters.

### BACKGROUND

In an ever increasing world of smart devices and smarter technologies the computing capabilities and the overall capability of these devices are expected to keep up with everyday life and activities. For example, tasks such as downloading a video or sending an email with a larger attachment require larger computing capabilities, and the general expectation is to achieve these tasks in a short time span. Most wireless systems utilized to implement smart devices and smart technologies are governed and guided by a set of wireless connectivity standards or protocols. A wireless connectivity standard or protocol are a set of media access control (MAC) and physical layer (PHY) specifications and guidelines for implementing the wireless systems. The PHY may include both analog circuitry and digital circuitry.

Higher computing capabilities and overall capabilities of smart devices are usually defined within these standards and governed with analog bandwidth and digital bandwidth of components within the line-up of the PHY circuitry of the smart device. The larger the bandwidth the higher capability of the smart device. Wireless connectivity standards usually define several levels of bandwidth depending on the application. A wireless system is implemented to accommodate for the largest bandwidth. Designing the wireless system to accommodate for the largest bandwidth has its setbacks. The system, while efficient for larger bandwidth requirement, is an over design for the smaller bandwidth levels, causing the system to be less efficient for the smaller bandwidth levels. One approach to reduce inefficiencies of such a design is implemented in the digital domain, where the digital bandwidth is programmable to reduce the bandwidth based on the prior information about the bandwidth. Though this approach helps to reduce the inefficiencies of such system, it still leaves a lot to be desired in terms of efficiency.

Another measure to define the capability of the smart device is the data rate or data transfer or throughput, which are used interchangeably in the present application. Data rates are the speeds by which data are transmitted from one device to another. Data rate depends on the application. For some applications, it is desirable to employ one wireless standard connectivity technology without the need for the entire data bandwidth all the time. In addition, in most of real life wireless applications, both data rate and link budget are asymmetrical in nature, where if sensitivity performance of the wireless receiver can be boosted for specific devices or under certain conditions, it does not imply an improvement of the overall system performance.

For example, although data rate requirements are not high for many Internet of things (IoT) applications, the distance coverage requirement is high for the IoT applications. Many wireless devices are battery powered, where battery life can be greatly impacted when the output power of the wireless device is required to match the direct output power of an access point wireless device (e.g., WiFi access point). It is critical to protect network management packets like acknowledgment packets or connection setup packets. The loss of the network management packets may result in a drop of the application throughput or an increase of setup latency. Accordingly, there is a need in the art for a wireless system that handles multiple bandwidths with a high level of efficiency and manages link budget issues arising from the asymmetric nature of real life wireless applications.

### SUMMARY

The disclosed subject matter relates to a system. The system includes a narrow band transmitter. The narrow band transmitter includes at least a delta sigma phased locked loop (delta-sigma PLL) circuit and a non-linear low-power amplifier, where an output of the delta-sigma PLL is coupled to an input of the non-linear low-power amplifier. The system further includes a wide band transmitter. The wide band transmitter includes at least a digital-to-analog converter (DAC), a low pass filter, a local oscillator mixer and a linear high power amplifier, where an output of the DAC is coupled to an input of the low pass filter and an output of the low pass filter is coupled to an input of the local oscillator mixer and wherein an output of the local oscillator mixer is coupled to an input of the linear high power amplifier.

The disclosed system further relates to a method to configure a transmitter side wireless system. The method includes detecting a short data packet and a management packet, separating the short data packet and the management packet into a phase component and an envelope component utilizing a baseband modulator; modulating the phase component utilizing a phase modulator, modulating the envelop component utilizing an envelope modulator, combining the phase component and the envelop component, and amplifying the combined phase component and envelop component. The method further includes detecting low-rate data packets and high-rate data packets, modulating the low-rate data packets and the high-rate data packets utilizing a wide band modulator, adjusting the bandwidth of a wide band transmitter lineup components upon detecting the low-rate data packets, up converting the low-rate data packets and the high-rate data packets utilizing a wide band transmitter lineup, and amplifying the short data packet and the management packet utilizing the wide band linear power amplifier.

It is understood that other configurations of the subject technology will become readily apparent to those skilled in the art from the following detailed description, wherein various configurations of the subject technology are shown and described by way of illustration. As will be realized, the subject technology of other different configurations and its several details are capable of modifications in various other respects, all without departing from the subject technology. Accordingly, the drawings and the detailed description are to be regarded as illustrative in nature and not restrictive.

### BRIEF DESCRIPTION OF DRAWINGS

Certain features of the present disclosure are set forth in the appended claims. However, for purpose of explanation, several implementations of the present disclosure are set forth in the following figures.

FIG. 1 illustrates an exemplary block diagram of a transmitter-side wireless system in accordance with one or more embodiments of the present disclosure.

FIG. 2 illustrates an exemplary block diagram of a receiver-side wireless system in accordance with one or more embodiments of the present disclosure.

FIG. 3A illustrates a flow chart of a method to configure a narrow band transmitter-side wireless system in accordance with one or more embodiments of the present disclosure.

FIG. 3B illustrates a flow chart of a method to configure a wide band transmitter-side wireless system in accordance with one or more embodiments of the present disclosure.

FIG. 4 illustrates a flow chart of a method to configure a receiver-side wireless system in accordance with one or more embodiments of the present disclosure.

FIG. 5 illustrates conceptually an example electronic system with which some implementations of the present disclosure may be implemented.

Embodiments of the present disclosure and their advantages are best understood by referring to the detailed description that follows. It should be appreciated that like-reference-numerals are used to identify like-elements illustrated in one or more of the figures.

### DETAILED DESCRIPTION

The detailed description includes specific details for the purpose of providing a thorough understanding of the present disclosure. However, the present disclosure is not limited to the specific details set forth herein and may be practiced without these specific details. In some instances, structures and components are shown in block diagram form to avoid obscuring the concept of the present disclosure.

The present disclosure discloses a transmitter-side wireless system and a receiver-side wireless system. The transmitter-side wireless system may be a network access point, such as a wireless access point (WAP). In some aspects, the WAP is sourced via direct power. The transmitter-side wireless system may also be a transmitter within a mobile device communicating with the WAP. In this case the transmitter within the mobile device is battery operated, raising the issue of battery efficiency and longevity. The present disclosure proposes a transmitter and receiver architectures to address battery longevity and link budget issues arising from the asymmetric nature of real life wireless applications.

The transmitter architectures proposes two line-up paths. Since short packets and management packets usually require narrow bandwidth architecture, the first line-up path is a narrow band line-up path to handle short packets and management packets. The packets are modulated using a narrow band modulation scheme. The line-up path is further reduce by eliminating up converters and digital-to-analog converters (DACs). The signal is amplified at the last stage using a non-linear high efficiency power amplifier (e.g., a class D amplifier). In some aspects, data packets which are classically long high data rate packets are handled by the second line-up path. The second line-up path is a wide band line-up path, where the packets are modulated using a wide band method such as a spread spectrum technology. The data packets are further up converted, filtered, and converted from a digital format to an analog format in preparation for transmission. The signal is amplified utilizing a linear high power amplifier to guarantee meeting the link budget of the application.

In at least one embodiment, low rate data are handled via the wide band line-up path. In this configuration the components of the wide band line-up path are programmed to smaller bandwidth that is sufficient to handle the low rate data but boost the link budget of the low rate data to meet the wireless connectivity standard of the application (via utilizing the linear high power amplifier). Programming the components to smaller bandwidth provide current saving to achieve a higher efficiency device. In at least another one embodiment, the narrow band line-up path may utilize the linear high power amplifier to achieve a boost in power for the narrow band line-up path.

For the receiver architecture, the present disclosure proposes two line-up paths as well. The first line-up path is to handle narrow band signals. The second line-up path is to handle wide band signals. Both wide and narrow bands line-up paths are processed simultaneously at the beginning of a received signal packet until bandwidth usage is determined where one of the line-up path can be turned off (i.e., the line-up path not in use) until the next received signal packet.

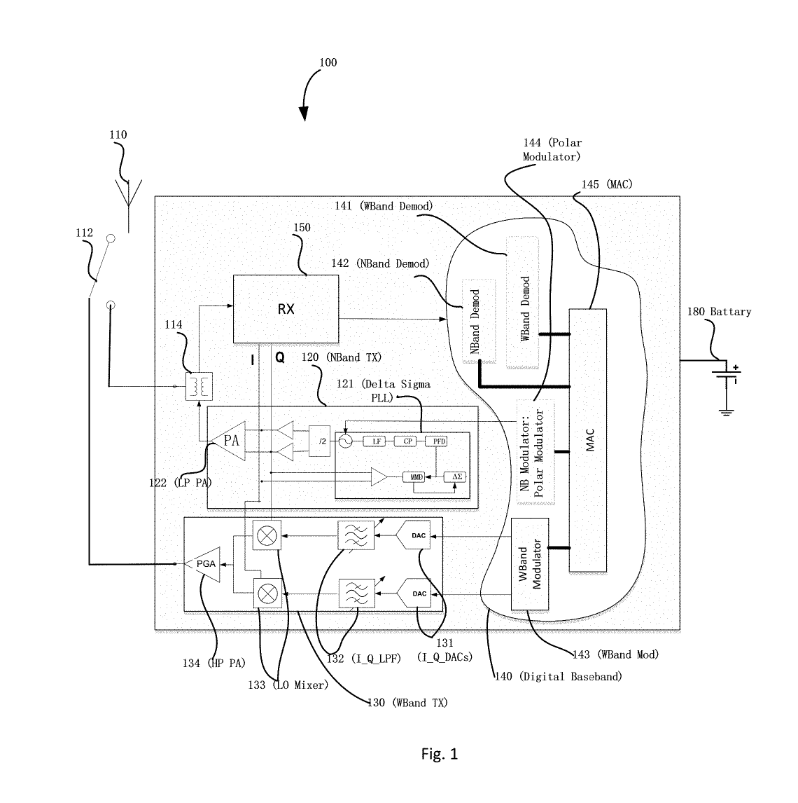

FIG. 1 illustrates an exemplary block diagram of a transmitter-side wireless system 100 in accordance with one or more embodiments of the present disclosure. Not all of the depicted components may be required. However, one or more implementations may require additional components, fewer components or different component not shown in receiver wireless system 100. Thus, any variations in receiver wireless system 100 may be implemented without departing from the scope of the present disclosure.

The transmitter-side wireless system 100 may include an antenna 110, an antenna switch 112, a front end module 114, a narrow band transmitter (NB-TX) 120, a wide band transmitter (WB-TX) 130, a digital baseband 140, and a receiver module 150. In some aspects, the wide band transmitter 130 (e.g., higher data rate transmitter) is a high-power consumption transmitter, while the narrow band transmitter 120 is a low-power consumption transmitter. In at least one embodiment, the transmitter-side wireless system 100 is operated under time division duplex (TDD) access mode, allowing antenna 110 sharing between the NB-TX 120, receiver module 150 and WB-TX 130 utilizing the switch 112.

The digital baseband 140 may include at least a MAC 145, a narrow-band modulator 144, a wide-band modulator 143, a narrow-band demodulator 142 and a wide-band demodulator 141. The MAC may perform media access functionality. In one of more implementations, the wide-band demodulator 141 and wide-band modulator 143 are a spread spectrum consisting of a wide band demodulator and a wide band modulator to support different modulation schemes. The narrow-band demodulator 142 is a narrow band demodulator and the narrow band modulator 144 is a narrow band modulator, where both support different modulation schemes.

In at least one embodiment, the narrow-band transmitter (NB-TX) 120 may include a low-power amplifier (LP-PA) 122, frequency divider, intermediate amplifier stages and a delta-sigma phase-locked-loop (Delta-Sigma PLL) 121. In one or more implementations, the Delta-Sigma PLL 121 may include a reference frequency (e.g., crystal oscillator), a low pass filter, a charge pump (CP), a phase frequency detector (PFD), a Multiple-modulator fractional-N divider MMD, a delta-sigma module (ΔΣ) for noise shaping. In one or more implementations, the LP-PA 122 is a non-linear power amplifier (e.g., a switched-mode power amplifier). The NB-TX 120 may be connected to the narrow-band modulator 144 (e.g., a Polar Modulator) within the digital baseband 140.

In some aspects, the narrow-band modulator 144 (e.g., Polar Modulator) employs a polar modulation scheme utilizing envelope and phase components to represent the baseband symbols of the information that is being transmitted, where the baseband symbols are originated from the MAC 145. In this approach, the baseband signal is a complex signal represented by an envelope component and a phase component (i.e., a constant-envelop phase-only signal). The phase component phase modulated in a phase-modulation path (e.g., Delta-Sigma PLL 121) and is multiplied with the envelope component passing through an envelope-modulation path in the switched-mode power amplifier LP-PA 122 to reconstruct the original baseband complex signal at the output of the LP-PA 122. The Delta Sigma PLL 121 enables phase modulation function when the fractional division ratio is modulated by the baseband signal. This approach allows simplifying the overall transmitter architecture without requiring digital-to-analog converters (DACs) or radio-frequency (RF) up-converters.

In one or more implementations, the NB-TX 120 may support both frequency hopping and spread spectrum wireless protocols, where the LP PA 122 allows for current saving with potential for achieving higher link budget due to smaller allocated bandwidth within the NB-TX lineup. However, with an additional RF switch (not shown), the NB-TX 120 may utilize the high power HP-PA 134 for additional gain and a higher link budget. Different transmitter architecture may also be implemented without departing from the scope of the present disclosure as long as the DACs and filters are designed to work with narrow bandwidth where the bandwidth is matching on the receiving end (i.e., receiver module 150).

In at least one embodiment, the wide band transmitter (WB-TX) 130 may include a high-power amplifier (HP-PA) 134, a local oscillator mixer (LO-Mixer) 133, in-phase and quadrature component low pass filters (I-Q_LPFs) 132 and in-phase and quadrature component digital-to-analog converters (I-Q_DACs) 131. In one or more implementations, the WB-TX 130 is connected to the wide-band modulator 143 within the digital baseband 140. In operation, the baseband signal originated from the MAC 145 goes through the wide-band modulator 143, where any modulation scheme is implemented based on the desired data rate of that signal. The modulated baseband signal may be an in-phase component (I_data) and quadrature component (Q_data), and is converted to an analog signal via the I-Q DACs 131 and then filtered through the I_Q_LPFs 132. The filtered signal is up-converted to an RF signal through the LO Mixer 133 and then amplified employing the HP-PA 134.

In some aspects, the I_Q_DACs 131 and I_Q_LPF 132 may be designed to meet wide bandwidth requirement. For instance, the I_Q_LPF 132 bandwidth may be designed to be programmable from 6 MHz to 20 MHz with a 2 MHz resolution to meet the 802.11b Wi-Fi wireless connectivity standard. Different bandwidths may be designed to meet different wireless connectivity standards without departing from the scope of the present disclosure. Furthermore, a DAC sampling rate and a reconstruction low pass filter bandwidth within the I_Q_DACs 131 may be designed to be programmable as well. For optimum performance, the setting of bandwidth selection on the receiver module 150 needs to match the bandwidth selection of I_Q_DACs 131 and I_Q_LPF 132. In at least one embodiment, HP-PA 134 may also be shared with the NB-TX 120.

In operation, in the transmission mode, the MAC 145 may generate either a data packet (e.g., from a TX first-in-first-out (FIFO) mode) or a network management packet (e.g., from a pre-programmed configuration based on the wireless connectivity protocol in use). For instance, short packets (e.g., short data packets) and network management packets (which may be short packets) may be selected to be transmitted through either the NB-TX 120 path or WB-TX 130 path with a reduced bandwidth selection. The short packets and network management packets are being modulated for different modulation scheme in the physical layer (PHY) through either the wide-band modulator 143 or the narrow-band modulator 144. Data digital bits of the data packets or short packets may be then converted to an analog signal employing the I_Q_DACs 131. The analog signal may be further filtered by the I_Q_LPF 132, up-converted by the LO Mixer 133, amplified by the HP-PA 134 and finally transmitted out through the antenna 110. On the other hand, data packets with low data rate modulation scheme may be modulated employing the narrow-band modulator 144 (i.e., polar modulator) where the phase component and envelop component of the signal are separated, and passed to thee NB-TX 120. In one or more implementation, the phase component is processed by the Delta-Sigma PLL 121 and the envelop component is controlled by the output level of the LP-PA 122.

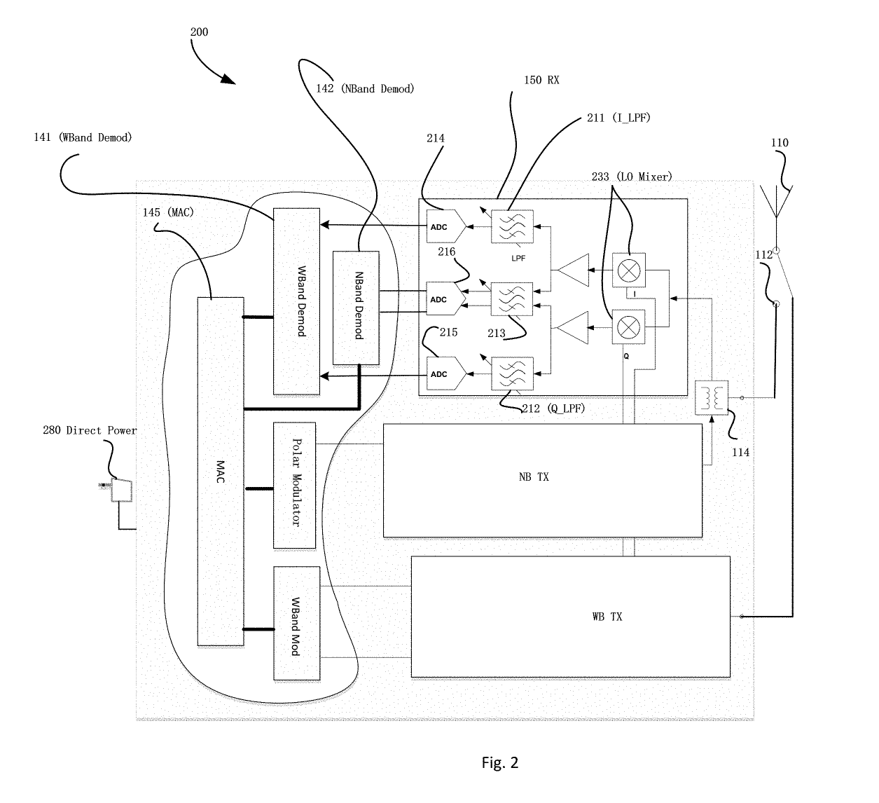

FIG. 2 illustrates an exemplary block diagram of a receiver-side wireless system 200 in accordance with one or more embodiments of the present disclosure. Not all of the depicted components may be required. However, one or more implementations may require additional components, fewer components or different component not shown in the receiver-side wireless system 200. Thus, any variations in the receiver-side wireless system 200 may be implemented without departing from the scope of the present disclosure.

The receiver-side wireless system 200 may include an antenna 110, an antenna switch 112, a front end module 114, a narrow band transmitter (NB-TX) 120, a wide band transmitter (WB-TX) 130, a digital baseband 140, and a receiver module 150. In some aspects, the WB-TX 130 (e.g., higher data rate transmitter) is a high-power consumption transmitter, while NB-TX 120 is a low-power consumption transmitter. In at least one embodiment, the receiver-side wireless system 200 is operated under time division duplex (TDD) access mode, allowing antenna 110 sharing between the NB-TX 120, receiver module 150 and WB-TX 130 utilizing switch 112.

Similar to the transmitter-side wireless system 100, the digital baseband 140 may include at least a MAC 145, a narrow-band modulator 144 and a wide-band modulator 143, a narrow-band demodulator 142 and a wide-band demodulator 141. The MAC may perform media access functionality. In one of more implementations, the wide-band demodulator 141 and wide-band modulator 143 are a spread spectrum technology consisting a wide band demodulator and a wide band modulator to support different modulation schemes. The narrow-band demodulator 142 is a narrow band demodulator and the narrow band modulator 144 is a narrow band modulator to support different modulation schemes.

In at least one embodiment, a receiver module 150 may include a programmable bandwidth low pass filter for an I_data (e.g., I_LPF 211), a programmable bandwidth low pass filter for a Q_data ((e.g., Q_LPF 212), a complex band pass filter for both I_data and Q_data ((e.g., Complex BPF 213), an oversampled delta-sigma analog to digital converter for I_data ((e.g., I_ADC 214), an oversampled delta-sigma analog to digital converter for Q_data ((e.g., Q_ADC 215), and an oversampled delta-sigma analog to digital converter for both I_data and Q_data ((e.g., Complex ADC 216). The I_LPF 211, the I-ADC 214, the Q_LPF 212 and the Q-ADC 215 represent a wide band path. The narrow band path include Complex BPF 213 and Complex ADC 216. The receiver module 150 may further include intermediate stages amplifiers and an LO mixer 233, where the LO mixer is an in-phase and quadrature components mixer architecture.

In at least one embodiment, binary selection between wide band path and narrow band path, is utilized. Additional programmability to adjust bandwidth within a selected path is available. For example, filter bandwidth of the I_LPF 211 and Q_LPF 212 are programmable (e.g., in the range of 6-20 MHz with a resolution of 2 MHz). Noise shaping bandwidth of Sigma Delta ADCs I_ADC 214 and Q_ADC 215 may be programmable as well. Dynamic range of the I_LPF 211 and Q_LPF 212 may also be programmable by changing the sampling frequency of the filter. The use of programmability has two advantages: first advantage is targeting intentional reduction of bandwidth to increase the link budget with tradeoff of data rate and the second advantage is autonomously trying to match remote transmit bandwidth to achieve an optimum performance.

In operation, in the reception mode, when receiving an RF signal through the antenna 110, the RF signal is down-converted to either an intermediate frequency (IF) or a baseband frequency depending on the receiver architecture without departing from the scope of the present disclosure. The down-converted signal has two components, I data and Q data, which are fed to the wide band path (i.e., I_LPF 211, Q_LPF 212, I_ADC 214 and Q_ADC 215). The wide band path is utilized to process high data rate signals with wider bandwidth allocation, while narrow band path is utilized to process narrow band signal with narrow bandwidth allocation requirements. In one or more implementations, wide band and narrow band path are processed simultaneously at the beginning of the received packet until bandwidth usage is determined. As a result of the determination, one of the narrow band path or the wide band path may be turned off until the next received packet. This approach enables power saving within the receiver module 150.

On the digital baseband 140, both the narrow-band demodulator 142 and wide-band demodulator 141 are utilized to process I data and Q data received from the receiver module 150. Once the demodulator recognizes the preamble of the received packet, the demodulator determines the packets nature (e.g., management packet, short data packet or data packet). The MAC 145 further configures the receiver module 150 to turn off the invalid path based on the determination. The MAC 145 needs to categorize different packets for different TX line-up paths based on many factors including data rate, link quality, coverage distance and latency. For network management packets are usually short packets and the integrity of management packets is critical. Hence, it is more desirable to have better sensitivity or lower packet error rate (PER) for management packets. On the transmitter side, it is good to assume that all network management packets may be processed through the narrow band path by going through the polar modulator 144, utilizing the LP_PA 122 to save current without trading off performance.

As depicted in FIG. 1 and FIG. 2, once the packet to be transmitted is determined to be either a short packet or a network management packet by the MAC 145, the packet may be processed via one of two options. The first option is to process the packet as a narrow band path going through the narrow-band modulator 144 and NB-TX 120. The second option is to process the packet as a wide band path, through the wide-band modulator 143 and WB-TX 130; reducing the bandwidth of the components on the wide band path. For instance, the short packet going through the wide band path option the allocated bandwidth may be as small as 1-2 MHz compared to the 20 MHz bandwidth assigned in the 802. 11b wireless connectivity standard. In this scenario there is roughly a 10 dB link budget gain to recover assuming the same process gain. The same packet can be transmitted using the LP-PA 122 at 10 dB lower output power to achieve the same link budget. For a device that is battery powered, it is a good tradeoff.

On the receiving side, since the receiver has to support both wide and narrow band traffic, where it does not have any prior identifier or early indicator to distinguish between narrow band vs. wide band received signals, the receiver has to process incoming a packet through different bandwidth paths and once the demodulator can determine whether the packet is a narrow band or wide band packet, it can disable the invalid path to save current. Besides determining between narrow and wide band paths, there is an additional option of adjusting bandwidth within the wide band path. The adjustment of bandwidth is done through the I_LPF 211, Q_LPF 212, I_ADC 214, and Q_ADC 215 and wide band demodulator 141. The receiver-side system 200 may autonomously reduce the bandwidth to find the best receiving performance for a number of received packets. In some aspects, the receiver-side system 200 may follow a pre-defined packets exchanged pattern (e.g., a traffic packet pattern) to utilize bandwidth adjustment.

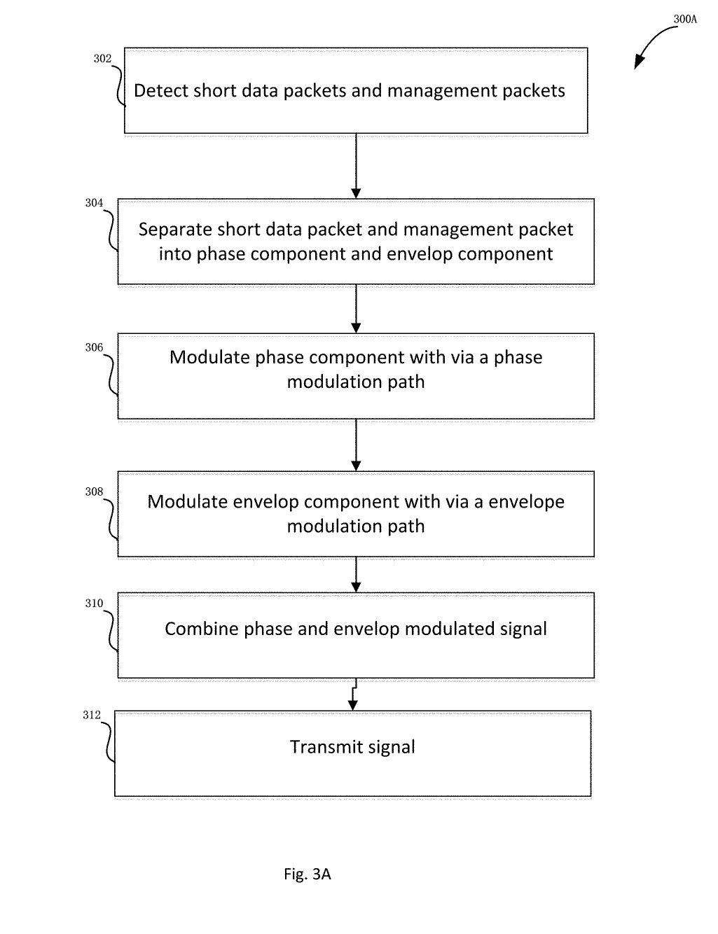

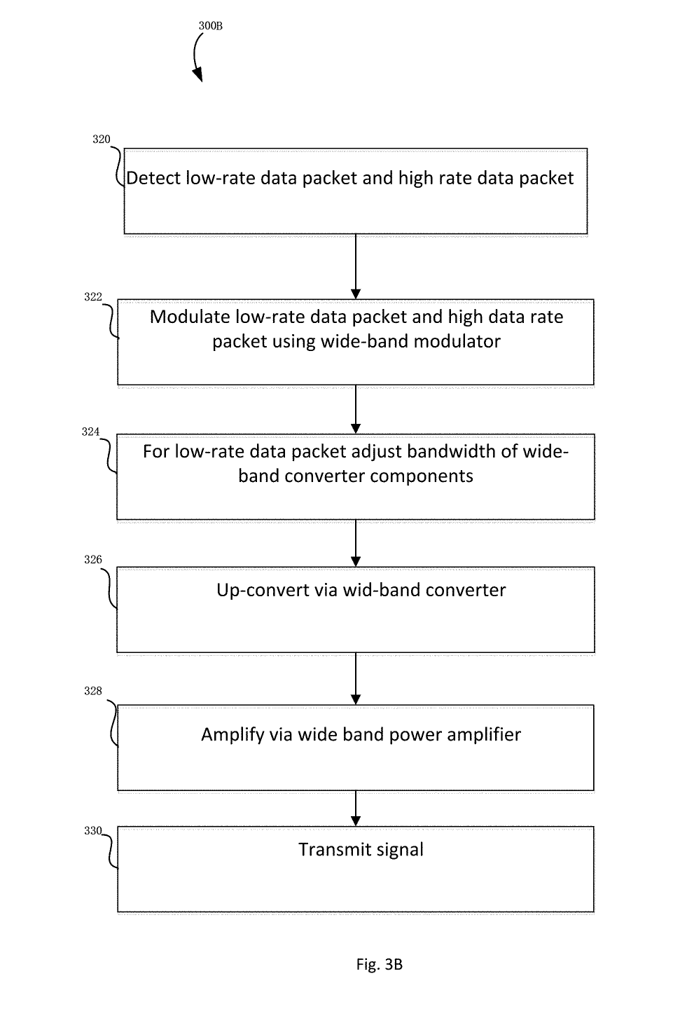

FIG. 3A illustrates a flow chart of a method 300A to configure a narrow band transmitter-side wireless system in accordance with one or more embodiments of the present disclosure. The narrow band transmitter side wireless system may correspond to the NB-TX 120 as described in FIG. 1. The method includes detecting and categorizing the transmitter side packets, and based on the detection the packets are recognized as short data packets or management packets, as shown at step 302. Based on detecting the short packets and the management packets are passed to the narrow band modulator 144 and are separated in an envelope component and a phase component, as shown in step 304.

At step 306, the phase component is passed through a phase modulation path (e.g., Delta-Sigma PLL 121) to modulate the phase component. On the other hand, at step 308, the envelop component is passed through an envelope modulator path (e.g., the LP-PA 122). As depicted in FIG. 1 the phase component and the envelop component are combined later to form a complex signal as shown at step 310 utilizing the LP-PA 122. The output of the LP-PA 122, is an amplified modulated signal that is ready to be transmitted, step 312. In one or more implementations, the narrow band signal is amplified utilizing the WB-PA 134, where a switch (not shown) is utilized to switch the signal path from the narrow band path to the wide band path.

FIG. 3B illustrates a flow chart of a method 300B to configure a wide band transmitter-side wireless system in accordance with one or more embodiments of the present disclosure. The wide band transmitter side wireless system may correspond to the WB-TX 130 as described in FIG. 1. The method includes detecting and categorizing the transmitter side packets, and based on the detection the packets are recognized as low-rate data packets or high-rate data packets, as shown at step 320. Based on the detecting the low-rate data packet and high-rate data packet are passed to the wide band modulator 143, as shown at step 322. In one or more implementations, the wide band modulator 143 is spectrum spread modulator as depicted in FIG. 1.

At step 324, the wide band modulated packets are passed to the WB-TX 130 for further processing. The bandwidth of the components on the WB-TX 130 are programmed and adjusted to a narrower bandwidth. The wide band modulated packets are then up converted to an RF signal as illustrated at step 326. At step 328, the up converted signal is then amplified utilizing the WB-PA 134 as described in FIG. 1. The amplified signal is then transmitted at step 330 through the antenna 110.

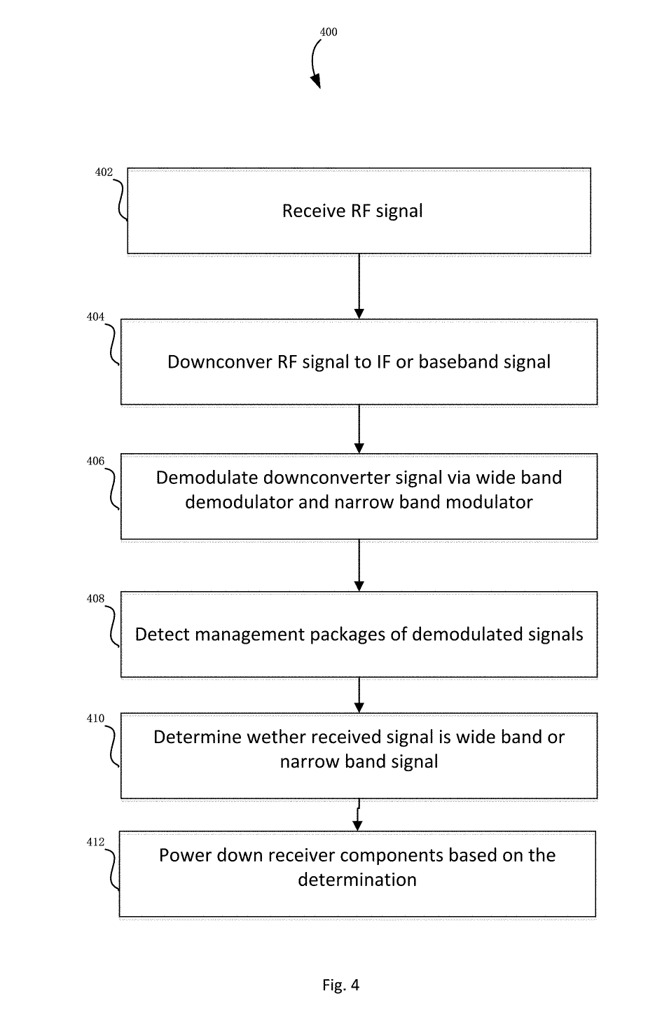

FIG. 4 illustrates a flow chart of a method 400 to configure a receiver-side wireless system in accordance with one or more embodiments of the present disclosure. The receiver side wireless system may correspond to the receiver module 150 as described in FIG. 2. At step 402, the method includes receiving an RF signal at the antenna 110. At step 404, the signal is down converted to an IF signal or a baseband signal utilizing an LO mixer, such as depicted in FIG. 2. The down converted signal may go a set of intermediate filtering, amplifying and conversion from an analog signal to a digital signal. The digital signal is then demodulated on utilizing the wide band demodulator 141 and narrow band demodulator 142 as shown at step 406.

At step 408, the MAC 145 detects the management packet portion of the received signal. At step 410, the MAC 145 further determines whether the received signal is a narrow band signal or a wide band signal. Based on the determination, the corresponding receiver components are powered down as shown at step 412.

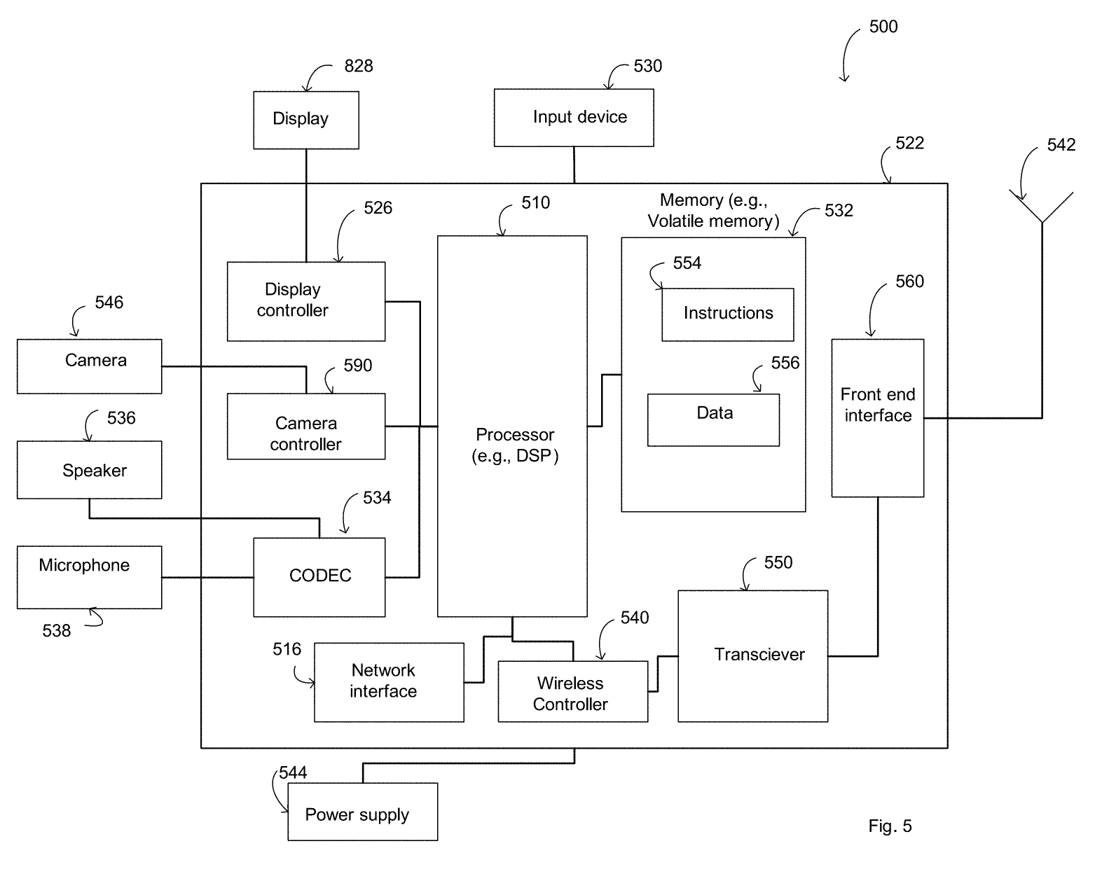

FIG. 5 illustrates conceptually an example electronic system 500 with which some implementations of the present disclosure may be implemented. Electronic system 500 may be a gateway device, a set-top box, a computer (e.g., desktop computer or laptop computer), a phone, a personal digital assistant (PDA), a server, a switch, a router, a base station, a receiver, or any other sort of electronic device that transmits signals over a network, such as electronic devices embedded in smart appliances and other smart systems. The electronic system 500 may be, and/or may be a part of, the proxy device and/or one or more of the smart devices. For example, the electronic system 500 may be a sensor, an active device, and/or an actuator. Such an electronic system includes various types of computer readable media and interfaces for various other types of computer readable media.

The electronic system 500 may include a processor 510, such as a digital baseband 140. The processor 510 may be coupled to a computer-readable storage medium, such as a memory 532 (e.g., a non-transitory computer-readable medium), via a transceiver 550. The transceiver 550 may correspond to transmitter-side wireless system 100 and/or receiver-side wireless system 200 as depicted in FIG. 1 and FIG. 2. Moreover, as depicted in FIG. 5, the processor 510 may be external transceiver 550. For example, the processor 510 may be “off-chip” with respect to the transceiver 550. In another embodiment, the processor 510 and the transceiver 550 are integrated within a system-in-package or system-on-chip device 522, as explained further below.

The memory 532 may store instructions 554 that are executable by the processor 510, data 556 that is accessible to the processor 510, or a combination thereof. In a particular embodiment, the memory 532 is a volatile memory that is accessible to the processor via transceiver 550. FIG. 5 also shows a display controller 526 that is coupled to the processor 510 and to a display 528. A coder/decoder (CODEC) 534 may also be coupled to the processor 510. A speaker 536 and a microphone 538 may be coupled to the CODEC 534. FIG. 5 also indicates that a wireless controller 540 may be coupled to the processor 510. The wireless controller may be further coupled to an antenna 542 via a transceiver 550. A camera 546 may be coupled to a camera controller 590. The camera controller 590 may be coupled to the processor 510.

In a particular embodiment, the processor 510, the memory 532, the display controller 526, the camera controller 590, the CODEC 534, the wireless controller 540, and the transceiver 550 are included in the system-in-package or system-on-chip device 522. An input device 530 and a power supply 544 may be coupled to the system-on-chip device 522. The power supply 544 may correspond to direct supply 280 as depicted in FIG. 2 or battery 180 as depicted in FIG. 1. Moreover, in a particular embodiment, and as illustrated in FIG. 5, the display 528, the input device 530, the camera 546, the speaker 536, the microphone 538, the antenna 542, and the power supply 544 are external to the system-on-chip device 522. However, each of the display 528, the input device 530, the camera 546, the speaker 536, the microphone 538, the antenna 542, and the power supply 544 may be coupled to a component of the system-on-chip device 522. As a particular example, the processor 510 and the memory 532 are coupled to transceiver 550.

In connection with the present disclosure, a computer-readable storage medium (e.g., the memory 532) stores data (e.g., the data 556) that is accessible to a processor (e.g., the processor 510) during modes of operation of transceiver 550. The data 556 may be a method instructions as depicted in FIG. 3A, FIG. 3B and FIG. 4. The method instructions are executable by processor 510, where the instructions include steps on how to operate and configure the transceiver 550. Finally, as shown in FIG. 5, electronic system 500 couples to a network through a network interface 516. In this manner, the electronic system 500 may be a part of a network of computers (for example, a local area network (LAN), a wide area network (WAN), or an Intranet, or a network of networks, for example, the Internet. Any or all components of electronic system 500 may be used in conjunction with the subject disclosure. The network interface 516 may include cellular interfaces, WiFi interfaces, Infrared interfaces, RFID interfaces, ZigBee interfaces, Bluetooth interfaces, Ethernet interfaces, coaxial interfaces, optical interfaces, or generally any communication interface that may be used for device communication.

Those of skill in the art will appreciate that the foregoing disclosed systems and functionalities may be designed and configured into computer files (e.g. RTL, GDSII, GERBER, etc.) stored on computer-readable media. Some or all such files may be provided to fabrication handlers who fabricate devices based on such files. Resulting products include semiconductor wafers that are separated into semiconductor dies and packaged into semiconductor chips. The semiconductor chips are then employed in devices, such as, an IoT system, the electronic system 500, or a combination thereof.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor, and the storage medium may reside as discrete components in a computing device or user terminal.

Further, specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Where applicable, various embodiments provided by the present disclosure may be implemented using hardware, software, or combinations of hardware and software. In addition, where applicable, the various hardware components and/or software components, set forth herein, may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer-readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code may be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A system comprising:
a narrow band transmitter, wherein the narrow band transmitter comprises at least a delta sigma phased locked loop (delta-sigma PLL) circuit and a non-linear low-power amplifier, wherein an output of the delta-sigma PLL is coupled to an input of the non-linear low-power amplifier; and
a wide band transmitter, wherein the wide band transmitter comprises at least a digital to analog converter (DAC), a low pass filter, a local oscillator mixer and a linear high power amplifier, wherein an output of the DAC is coupled to an input of the low pass filter and an output of the low pass filter is coupled to an input of the local oscillator mixer and wherein an output of the local oscillator mixer is coupled to an input of the linear high power amplifier.

2. The system of claim 1, further comprising a narrow band modulator.

3. The system of claim 2, wherein the narrow band modulator is a polar modulator employing a polar modulation scheme resulting in converting a baseband complex signal to a constant envelop component and a phase component.

4. The system of claim 3, wherein the constant envelop component and the phase component are reconstructed into a complex amplified signal at an output of the non-linear low power amplifier.

5. The system of claim 1, further comprising a wide band modulator and wherein the wide band modulator is a spread spectrum modulator.

6. The system of claim 3, wherein an input of the delta-sigma PLL circuit is coupled to an output of the narrow-band modulator.

7. The system of claim 1, wherein the non-linear low power amplifier is a switched mode power amplifier.

8. The system of claim 1, further comprising a switch to add the linear high power amplifier to the narrow band transmitter.

9. The system of claim 1, wherein the DAC is an in-phase and quadrature component DAC, the low pass filter is an in-phase and quadrature component low pass filter and the local oscillator mixer is an in-phase and quadrature component mixer.

10. The system of claim 1, wherein the DAC and the low pass filter are bandwidth programmable.

11. A method for operating a system on a transmitter-side comprising:
detecting a short data packet and a management packet;
separating the short data packet and the management packet into a phase component and an envelope component utilizing a baseband modulator;
modulating the phase component utilizing a phase modulator;
modulating the envelop component utilizing an envelope modulator;
combining the phase component and the envelop component; and
amplifying the combined phase component and envelop component.

12. The method of claim 11 wherein the amplifying is performed utilizing a non-linear high efficiency amplifier.

13. The method of claim 11, wherein the phase modulator is a delta-sigma PLL.

14. The method of claim 11, wherein the baseband modulator is a polar modulator.

15. The method of claim 11, further comprising:
detecting low-rate data packets and high-rate data packets; and
modulating the low-rate data packets and the high-rate data packets utilizing a wide band modulator.

16. The method of claim 15 further comprising, adjusting the bandwidth of a wide band transmitter lineup components upon detecting the low-rate data packets.

17. The method of claim 16 further comprising, up converting the low-rate data packets and the high-rate data packets utilizing a wide band transmitter lineup.

18. The method of claim 17, wherein the wide band transmitter lineup comprises analog-to-digital converters, low pass filters, local oscillator mixers, and a wide band linear power amplifier.

19. The method of claim 15, further comprising amplifying the short data packet and the management packet utilizing the wide band linear power amplifier.

20. The method of claim 18, wherein the wide band transmitter lineup components are bandwidth programmable.
